(19) United States
(12) Patent Application Publication
(10) Pub. No.: US 2018/0315020 A1
(43) Pub. Date: Nov. 1, 2018

(54) SYSTEMS AND METHODS FOR AUTOMATED CANDIDATE OUTREACH

(71) Applicant: Facebook, Inc., Menlo Park, CA (US)

(72) Inventors: Daniel Shabtai, Sunnyvale, CA (US); James Nicholas Valner, Mountain View, CA (US); Nimrod Hoofien, Palo Alto, CA (US)

(21) Appl. No.: 15/582,452

(22) Filed: Apr. 28, 2017

(51) Int. Cl. G06Q 10/10; G06Q 50/00; G06N 99/00; G06N 7/00

(52) U.S. Cl. CPC G06Q 10/1053; G06Q 50/01; G06N 7/005; G06N 99/005; G06Q 10/107

(57) ABSTRACT

Systems, methods, and non-transitory computer-readable media can determine that a candidate is likely to leave a current employer employing the candidate based on one or more outreach timing machine learning models. An outreach message for the candidate is generated based on one or more content generation machine learning models in response to the determining that the candidate is likely to leave the current employer. The outreach message is transmitted to the candidate.

### FIELD OF THE INVENTION

The present technology relates to the field of recruiting systems. More particularly, the present technology relates to systems and methods for automated candidate outreach.

### BACKGROUND

Recruiters can play a primary role in helping organizations locate job candidates. In some cases, a recruiter can proactively seek job candidates for the organization. In other cases, job candidates can initiate contact with an organization through a recruiter of the organization. The process to assess job candidates often can be initiated through electronic receipt by the organization of a resume of a job candidate. An organization can receive large volumes of resumes. The sheer number of resumes received by such an organization can create challenges for the recruiter in vetting the resumes to identify job candidates suited to the organization or a particular job position.

### SUMMARY

Various embodiments of the present disclosure can include systems, methods, and non-transitory computer readable media configured to determine that a candidate is likely to leave a current employer employing the candidate based on one or more outreach timing machine learning models. An outreach message for the candidate is generated based on one or more content generation machine learning models in response to the determining that the candidate is likely to leave the current employer. The outreach message is transmitted to the candidate.

In an embodiment, the determining that the candidate is likely to leave the current employer comprises calculating, based on the one or more outreach timing machine learning models, a likelihood to leave score indicative of a likelihood of the candidate to leave the current employer; and determining that the likelihood to leave score satisfies a score threshold.

In an embodiment, the likelihood to leave score is calculated based on at least one of: an amount of time the candidate has been employed by the current employer; current employer stock price information; current employer acquisition information; and current employer benefit information.

In an embodiment, the outreach message is transmitted to the candidate in such a way that it appears to the candidate that the outreach message was transmitted by a recruiter.

In an embodiment, the outreach message is transmitted to the candidate using an email address associated with the recruiter.

In an embodiment, a response message responsive to the outreach message is received from the candidate. The response message is forwarded to the recruiter.

In an embodiment, the response message is forwarded to the recruiter based on a determination that the response message comprises a positive response to the outreach message.

In an embodiment, the outreach message comprises an invitation to apply for a position with a hiring employer.

In an embodiment, the generating the outreach message comprises: identifying one or more connections of the candidate on a social networking system that are employed by the hiring employer; and including at least one connection of the one or more connections in the outreach message.

In an embodiment, a response message responsive to the outreach message is received from the candidate, and the at least one connection is notified of the response message.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an automated candidate outreach module, according to an embodiment of the present disclosure.

FIG. 2 illustrates an example automated communication module, according to various embodiments of the present disclosure.

FIG. 3 illustrates an example scenario associated with automated candidate outreach, according to various embodiments of the present disclosure.

FIG. 4 illustrates an example method associated with automated candidate outreach, according to an embodiment of the present disclosure.

FIG. 5 illustrates an example method associated with automated communications with a candidate, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Automated Candidate Outreach

As mentioned, recruiters can play a primary role in helping organizations locate job candidates. In some cases, a recruiter can proactively seek job candidates for the organization. In other cases, job candidates can initiate contact with an organization through a recruiter of the organization. The process to assess job candidates often can be initiated through electronic receipt by the organization of a resume of a job candidate. Certain organizations can receive large volumes of resumes. The sheer number of resumes received by such organizations can create challenges for recruiters in vetting the resumes to identify suitable job candidates for a particular job position.

One common challenge confronted by organizations and their recruiters is effectively reviewing large numbers of resumes to identify qualified job candidates. Under conventional approaches, recruiters may perform keyword searches or electronically filter candidate information to identify resumes that satisfy certain criteria. Furthermore, once a set of job candidates is identified, recruiters are faced with the additional challenge of individually reaching out to each job candidate to invite the candidate to apply for a position with an organization. For example, under conventional approaches, recruiters may use computing devices to send electronic communications (e.g., emails) to large numbers of candidates to invite the candidates to apply. However, such outreach attempts by recruiters, even with the assistance of computing devices in sending electronic communications, are time-consuming and, very often, ineffective. A large percentage of candidates that are contacted about applying for a position with an organization may not be interested in applying. These candidates may either ignore the recruiter's communications or decline the recruiter's invitation to apply. Under conventional approaches, recruiters spend an inordinate amount of time identifying and reaching out to job candidates, many of whom will either ignore or decline the recruiter's invitation to apply for a job position. This is an inefficient and ineffective use of a recruiter's time and efforts.

An improved approach rooted in computer technology overcomes the foregoing and other disadvantages associated with conventional approaches specifically arising in the realm of computer technology. In general, a hiring employer may be seeking job candidates to potentially hire as new employees. One or more candidates can be automatically identified based on candidate selection criteria. For example, the candidate selection criteria can include job criteria specified by the hiring employer. In certain embodiments, one or more machine learning models can be utilized to automatically identify one or more candidates based on the candidate selection criteria. An outreach message can be automatically generated for and transmitted to each candidate of the one or more candidates. In certain embodiments, the outreach message can be transmitted on behalf of a recruiter, such that it appears that the outreach message has been drafted and transmitted by the recruiter. The outreach message can be, for example, an email that appears to be sent by a recruiter. The timing of when an outreach message is transmitted to a candidate can be automatically determined based on one or more machine learning models. In certain embodiments, the one or more machine learning models can be trained to calculate, for a particular candidate, a likelihood to leave score indicative of the likelihood that the candidate is interested in leaving his or her current job. If the likelihood to leave score indicates a sufficiently high likelihood that the candidate may be interested in leaving his or her current employer, an automated outreach message can be sent to the candidate. The content of the automated outreach message can be automatically generated. For example, one or more machine learning models can be trained to automatically determine message content that has the highest likelihood of appealing to the candidate and convincing the candidate to apply for a position with the hiring employer. If a candidate responds to an outreach message, the candidate's response can be routed to one or more parties, such as the recruiter on whose behalf the outreach message was sent. The recruiter can, from that point on, correspond directly with the candidate. The candidate is given the impression that the initial outreach message was sent by the recruiter and the recruiter's further communications are a continuation of the initial outreach message.

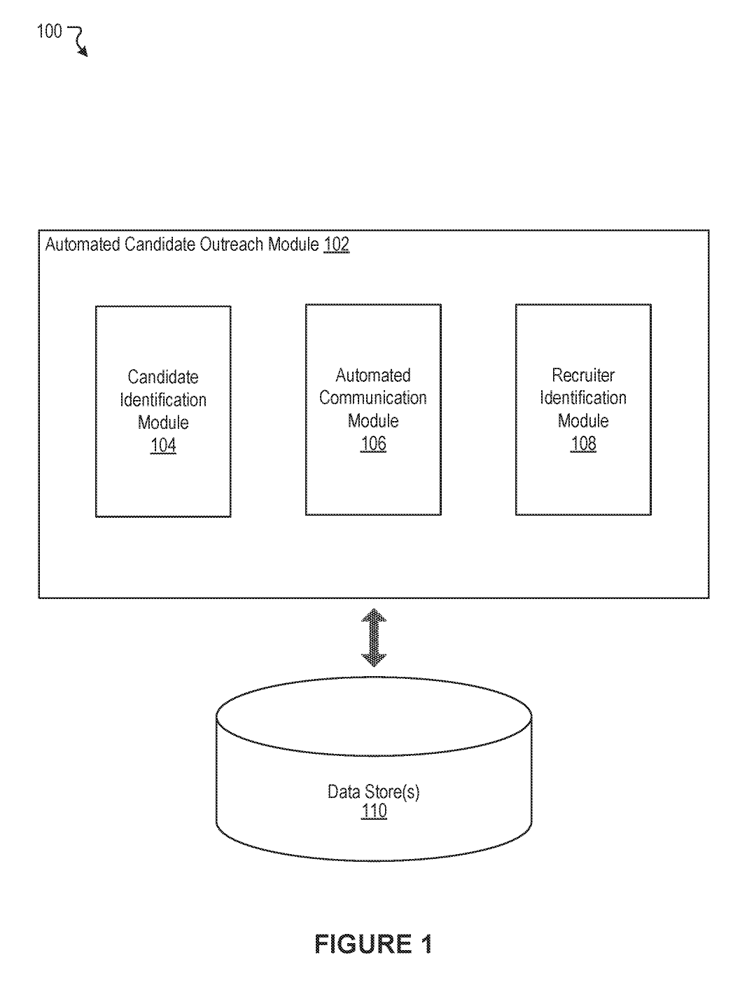

FIG. 1 illustrates an example system 100 including an example automated candidate outreach module 102, according to an embodiment of the present disclosure. The automated candidate outreach module 102 can be configured to automatically identify one or more candidates based on candidate selection criteria, and to automatically generate and transmit outreach messages to the one or more candidates. For example, a hiring employer may be looking to hire new employees. The hiring employee may specify various candidate selection criteria (e.g., job criteria) to be used in assessing potential job candidates. The automated candidate outreach module 102 can be configured to automatically review candidate resumes or other available candidate information to identify one or more candidates that satisfy the candidate selection criteria. An outreach message can be automatically generated for and transmitted to at least some of the one or more candidates. The outreach message can, for example, notify a candidate that the hiring employee is looking to hire new employees, and invite the candidate to apply.

The timing and content of each outreach message may be tailored for an individual candidate. For example, one or more machine learning models can be trained to determine when to send an outreach message to a candidate. When an outreach message is sent to a candidate may be determined, for example, based on a determination of how likely the candidate is to leave his or her current job. In certain embodiments, one or more machine learning models can be trained to determine content for an outreach message. An outreach message can be tailored such the outreach message contains content that is most likely to appeal to a particular candidate and, therefore, most likely to convince the candidate to inquire for more information about the hiring employer and/or to apply for a position with the hiring employer.

Each outreach message can be generated such that it appears to be coming from a recruiter working for the hiring employer. If a candidate responds to the outreach message, the candidate's response can be directed to the recruiter. The recruiter can “resume” the conversation with the candidate by responding directly to the candidate. In this way, a recruiter's time can be more efficiently utilized, as the recruiter is no longer tasked with sending outreach messages to each and every candidate, many of whom may not be interested in applying. When a candidate shows interest by responding to an initial outreach message, the recruiter can pick up the conversation. The candidate is given the impression that the outreach message was from the recruiter and that the candidate has been in communication with the recruiter from the beginning.

As shown in the example of FIG. 1, the automated candidate outreach module 102 can include a candidate identification module 104, an automated communication module 106, and a recruiter identification module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the automated candidate outreach module 102 can be implemented in any suitable combinations.

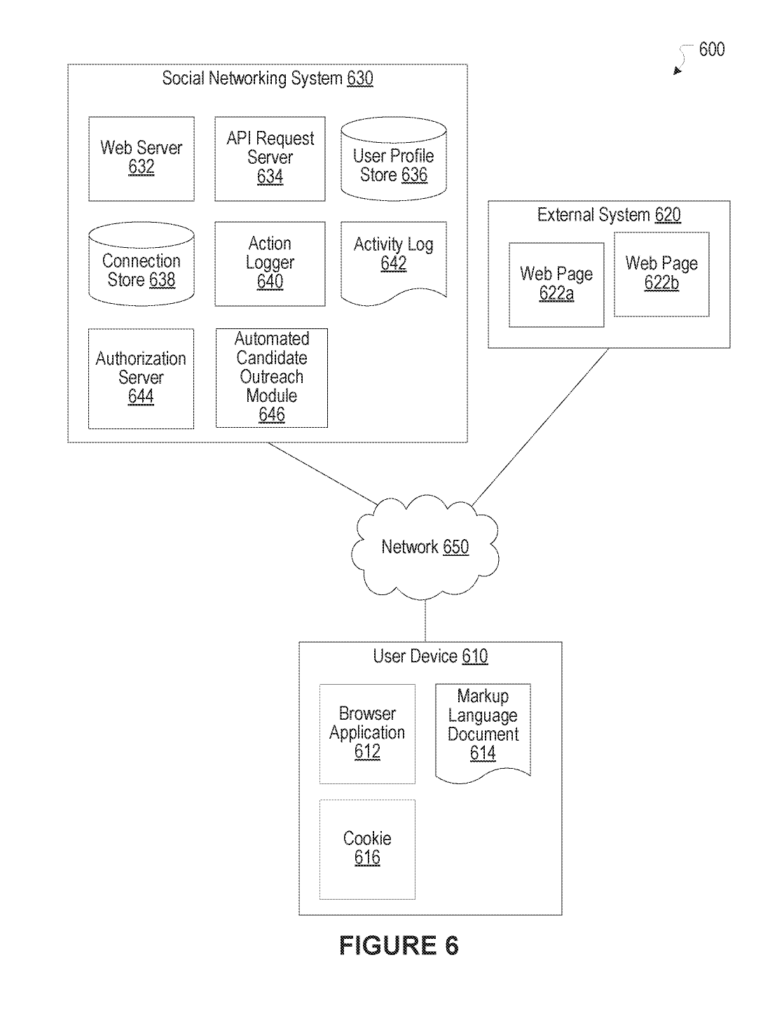

In some embodiments, the automated candidate outreach module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the automated candidate outreach module 102 can be implemented, in part or in whole, as software running on one or more computing devices or systems, such as on a user or client computing device. For example, the automated candidate outreach module 102, or at least a portion thereof, can be implemented as or within an application (e.g., app), a program, or an applet, etc., running on a user computing device or a client computing system, such as the user device 610 of FIG. 6. In another example, the automated candidate outreach module 102, or at least a portion thereof, can be implemented using one or more computing devices or systems that include one or more servers, such as network servers or cloud servers. In some instances, the automated candidate outreach module 102 can, in part or in whole, be implemented within or configured to operate in conjunction with a social networking system (or service), such as the social networking system 630 of FIG. 6. It should be understood that there can be many variations or other possibilities.

The automated candidate outreach module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the automated candidate outreach module 102. For example, the data store 110 can store resume information, candidate selection criteria, stock information, acquisition information, candidate information, various machine learning models, and the like. It is contemplated that there can be many variations or other possibilities.

The candidate identification module 104 can be configured to identify one or more candidates based on candidate selection criteria. The candidate selection criteria can comprise job criteria specified by a hiring employer looking to hire new employees. The one or more candidates can be selected from a set of potential candidates. The set of potential candidates can include, for example, applicants who have submitted their resumes to a hiring employee and/or potential candidates that have been identified based on talent searches. Candidate information for each potential candidate can be analyzed to determine whether the potential candidate satisfies the candidate selection criteria. For example, Boolean and/or keyword searches of candidate resumes or candidate files can be performed to identify candidates that satisfy the candidate selection criteria. Candidate information can include, for example, previous work experience information (e.g., previous employers, amount of time at previous employers, types of work performed for previous employers) and/or educational background information (e.g., schools attended, grades, accolades, courses taken, subjects studied), and the like. Any potential candidates that satisfy the candidate selection criteria can be identified for inclusion in the one or more candidates. In certain embodiments, a hiring employer may have multiple sets of candidate selection criteria, for example, for different job openings or different divisions or departments.

The automated communication module 106 can be configured to automatically generate and transmit an outreach message to a candidate. The automated communication module 106 can be configured to automatically generate an outreach message, for example, to invite the candidate to apply for a position with a hiring employer. In certain embodiments, one or more machine learning models may be trained and utilized to determine content for the outreach message that is most likely to be of interest to the candidate. The automated communication module 106 can be also configured to automatically determine when to send an outreach message to the candidate. In certain embodiments, the determination of when to send an outreach message to a candidate can be determined based on calculation of a likelihood to leave score indicative of the likelihood of the candidate to leave his or her current employer. In certain embodiments, one or more machine learning models can be utilized to calculate the likelihood to leave score. An outreach message can be automatically generated and transmitted to the candidate if the candidate's likelihood to leave score satisfies a score threshold. For example, satisfaction of the score threshold may indicate a sufficiently high likelihood that the candidate will leave and/or is interested in leaving the current employer. The automated communication module 106 is described in greater detail herein.

The recruiter identification module 108 can be configured to automatically determine a recruiter to be associated with an outreach message based on recruiter identification criteria. In certain embodiments, each outreach message can appear to have been drafted and transmitted by a recruiter. For example, the outreach message can be transmitted to a candidate from the recruiter's email address. In another example, the outreach message can include the recruiter's signature or signature block. In this way, the candidate is given the impression that the outreach message was sent by the recruiter, rather than being an automated outreach message.

In certain embodiments, an outreach message sent to a candidate can be associated with a particular job opening or a particular talent pipeline/department. For example, an outreach message sent to a candidate may include an invitation for the candidate to apply for a particular job opening, or to apply for a position within a particular department. The job opening, talent pipeline, and/or department may be associated with one or more recruiters. The recruiter for a particular outreach message may be selected based on the recruiter's association with the particular job opening, talent pipeline, and/or department associated with the outreach message.

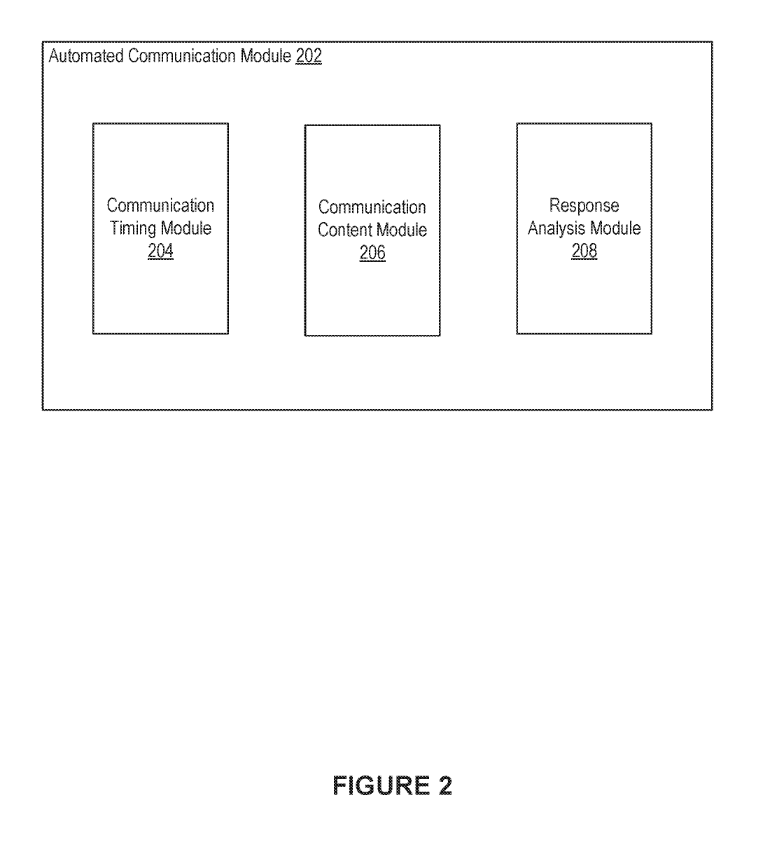

FIG. 2 illustrates an example automated communication module 202 configured to automatically generate and transmit an outreach message to a candidate, according to an embodiment of the present disclosure. In some embodiments, the automated communication module 106 of FIG. 1 can be implemented as the automated communication module 202. As shown in the example of FIG. 2, the automated communication module 202 can include a communication timing module 204, a communication content module 206, and a response analysis module 208.

The communication timing module 204 can be configured to automatically determine when to send an outreach message to a candidate based on outreach timing criteria. In certain embodiments, the determination of when to send an outreach message to a candidate may be based on a determination of how likely a candidate is to leave and/or consider leaving his or her current employer. In certain embodiments, the outreach timing criteria can be implemented, at least in part, using one or more outreach timing machine learning models. In certain embodiments, the one or more outreach timing machine learning models can be trained to calculate a likelihood to leave score for each candidate indicative of a likelihood of a candidate to leave his or her current employer. An outreach message can be sent to a candidate if the candidate's likelihood to leave score satisfies a score threshold.

In certain embodiments, the one or more outreach timing machine learning models can be trained based on past outreach messages, various features associated with each outreach message, and the outcomes of the past outreach messages to identify various features that may be useful in predicting the likelihood of a candidate to leave his or her current employer. For example, features can be identified that are indicative of a negative outcome (e.g., a candidate does not respond or declines an invitation to apply), and such features may be associated with a lower likelihood to leave. Similarly, features can be identified that are indicative of a positive outcome (e.g., candidate applies for a position or indicates interest in applying), and such features may be associated with a greater likelihood to leave. Features that may be useful in determining the likelihood of a candidate to leave his or her current employer can include, for example, candidate information and current employer information.

Candidate information can include any information about a candidate that may be useful in determining the likelihood of the candidate to leave his or her current employer. For example, candidate information can include the length of time the candidate has been with his or her current employer. If the candidate has been at his or her current job for a short period of time, the candidate may be less likely to leave. Conversely, if the candidate has been at his or her current job for a duration of time that is associated with a higher likelihood to leave (e.g., four years, which is a typical employment duration for stock options to fully vest), then the candidate may be more likely to be open to moving to a new position. Candidate information can also include social graph information, such as the number of social networking system connections of the candidate that work for the hiring employer. For example, if a candidate has more friends that work for the hiring employer, the candidate may be more likely to move from his or her current employer to the hiring employer.

Current employer information can include information about a candidate's current employer that may be useful in determining the likelihood of the candidate to leave the current employer. This can include, for example, changes in the current employer's stock price, an acquisition of the current employer by a new company, perks offered by the hiring employer that are not offered by the current employer, and the like. For example, a decrease in stock price of the current employer or an acquisition by another company may indicate a higher likelihood that the candidate would consider moving.

Although various examples of features that may be considered by the one or more outreach timing machine learning models have been discussed, it should be understood that more or fewer features may be considered.

The communication content module 206 can be configured to automatically generate an outreach message for a candidate based on content generation criteria. In certain embodiments, the content of an automatically generated outreach message can be determined based on one or more content generation machine learning models. The one or more content generation machine learning models can be trained based on past outreach messages, their content, and their outcomes to determine what types of content most effectively result in positive responses to an outreach message. For example, the one or more content generation machine learning models can be trained to determine content for an outreach message that is most likely to encourage a particular candidate to apply for or inquire about a job position.

The one or more content generation machine learning models can be trained based on various features to determine which features are most useful in selecting content for an outreach message in order to maximize the probability of a positive response to the outreach message. These features can include, for example, candidate information, current employer information, and/or hiring employer information. In various embodiments, candidate information can include any information about a candidate that may have an effect on what content should or should not be included in an outreach message to the candidate. Outreach messages can be tailored to an individual candidate. For example, a candidate that currently works at a small start-up company may be excited to hear about benefits offered by the hiring employer, e.g., free lunches or snacks provided by the hiring employer. Inclusion of that information in an outreach message may increase the likelihood of a positive response from that candidate. Conversely, a candidate that currently works at a large company that offers similar benefits or perks may have no interest in hearing about the similar benefits offered by the hiring employer. As such, inclusion of that information in an outreach message may have no effect, or even a negative effect on the likelihood of a positive response from that candidate.

In certain embodiments, candidate information can include social graph information. For example, the one or more content generation machine learning models may determine that an outreach message has a higher probability of a positive response if the outreach message identifies various people that work for the hiring employer that the candidate is connected to. As such, the one or more content generation machine learning models can generate an outreach message that identifies one or more of the candidate's connections on a social networking system that work at the hiring employer. The outreach message can also ask the candidate if he or she would like to contact the identified social networking system connections so that the candidate can ask them about their experience at the hiring employer.

In certain embodiments, current employer information can include information about a candidate's current employer that may have an effect on the determination of what types of content should or should not be included in a candidate's outreach message. For example, a drop in the current employer's stock price, an acquisition of the current employer by another company, salaries at the current employer that are lower than salaries offered by the hiring employer, a lack of perks or benefits at the current employer, an inconvenient location relative to the candidate's residence, and the like, can be included in an outreach message if it is determined by the content generation machine learning models that such content may increase the probability of a positive response. Hiring employer information can include information about a hiring employer that may have an effect on the determination of what types of content should or should not be included in a candidate's outreach message. This can include, for example, higher salary, more perks or benefits, a geographic location the candidate has expressed an interest in or that may be more convenient for the candidate, and the like.

Again, although various examples of features that may be considered by the one or more content generation machine learning models have been discussed, it should be understood that more or fewer features may be considered.

The response analysis module 208 can be configured to analyze any response message received from a candidate in response to an outreach message, and to take appropriate action, if any, based on the response message. For example, if a candidate sends a response message indicating that the candidate is not interested in leaving his or her current employer (e.g., “Thank you, but I am not interested.”), the response analysis module 208 can be configured to take no further immediate action with respect to the candidate. However, if the candidate sends a response message indicating interest in applying for a position with the hiring employer (i.e., a positive response), the response analysis module 208 can be configured to automatically forward the response message to one or more individuals. For example, the response message can be sent to a recruiter (e.g., the recruiter associated with the outreach message sent to the candidate), so that the recruiter can correspond directly with the candidate. The recruiter's direct correspondence with the candidate can be a continuation of the initial, automated outreach message. For example, the automated outreach message, the candidate's response message, and any additional communications between the candidate and the recruiter can be contained in a single, continuous email thread. In this way, although candidates were initially contacted using an automated outreach message, candidates can be given the impression that they have been in contact with a recruiter from the outset.

In certain embodiments, additional individuals may be notified based on the content of the response message. For example, an outreach message to a candidate may specify one or more connections of the candidate that are employed by the hiring employer, e.g., “I see that your friend John Smith works for Employer X. If you would like to speak to John about his experience at Employer X, we would be happy to reach out to him for you.” The response message may indicate an interest in contacting the one or more connections, e.g., “Yes, I would love to speak to John about what it's like to work at Employer X.” In such a scenario, the response analysis module 208 can be configured to forward the response message to the one or more connections, or otherwise notify the one or more connections of the candidate's interest in discussing their experience working with the hiring employer. In another example, a candidate may express interest in speaking with a hiring manager about open positions in a particular department. In this scenario, a hiring manager in the department may be notified of the candidate's response message. Once any additional individuals have been notified of the candidate's desire to communicate with them, the additional individuals can communicate directly with the candidate.

In certain embodiments, if the content of a response message indicates that an immediate response is required, one or more individuals may be notified of that fact. For example, if a candidate states that he or she would be available to interview the next day, the recruiter may be notified that the response message requires immediate review and/or response.

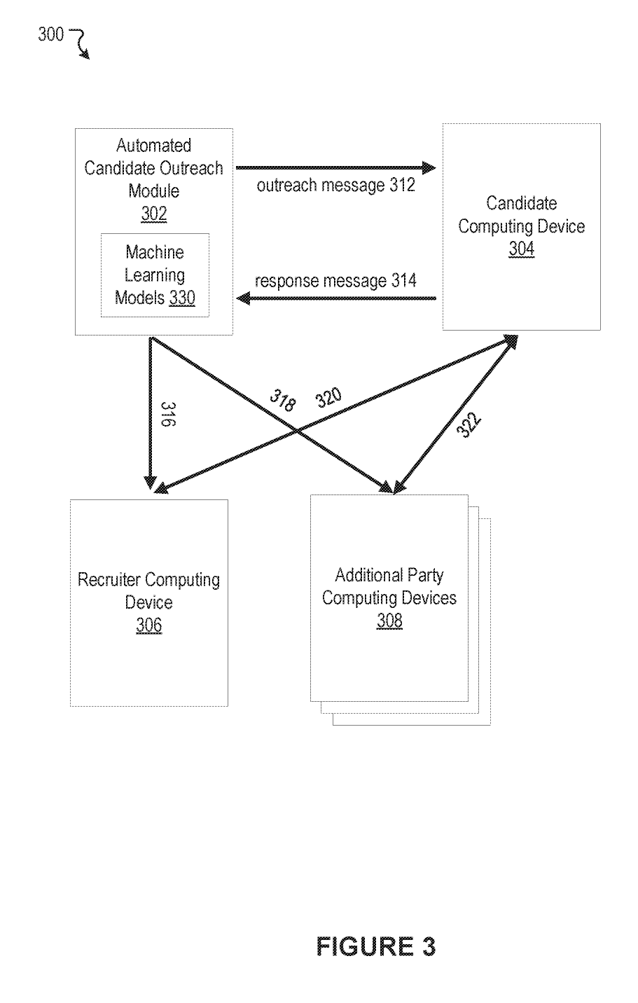

FIG. 3 illustrates a functional block diagram illustrating an example scenario 300 associated with automated candidate outreach, according to an embodiment of the present disclosure. The example scenario 300 includes an automated candidate outreach module 302, which may be implemented, for example, as the example automated candidate outreach module 102 discussed above. The automated candidate outreach module 102 includes one or more machine learning models 330, such as the outreach timing machine learning models and content generation machine learning models discussed above. The automated candidate outreach module 302 can automatically determine that it is an appropriate time to contact a candidate (e.g., the candidate is likely to leave the candidate's current employer), and can automatically generate and transmit an outreach message 312 to a candidate computing device 304. The outreach message 312 may, for example, invite the candidate to apply for a position with a hiring employer. The outreach message 312 may be generated and/or transmitted in such a way that it appears to be from a recruiter computing device 306. The candidate responds by transmitting a response message 314. In the example scenario 300, the response message 314 may indicate an interest in applying for a position with the hiring employer. Based on the indication of interest, a notification of the response message 314 can be transmitted to a recruiter computing device 306 (arrow 316). One or more additional party computing devices 308 can also receive notifications of the response message 314 as appropriate (arrow 318). Once the recruiter computing device 306 and/or the additional party computing devices 308 receive notification of the response message 314, the recruiter computing device 306 and/or the additional party computing devices 308 can communicate directly with the candidate computing device 304 (arrows 320 and 322). For example, the recruiter computing device 306 may receive the response message 314 as an email, to which the recruiter computing device 306 can respond directly.

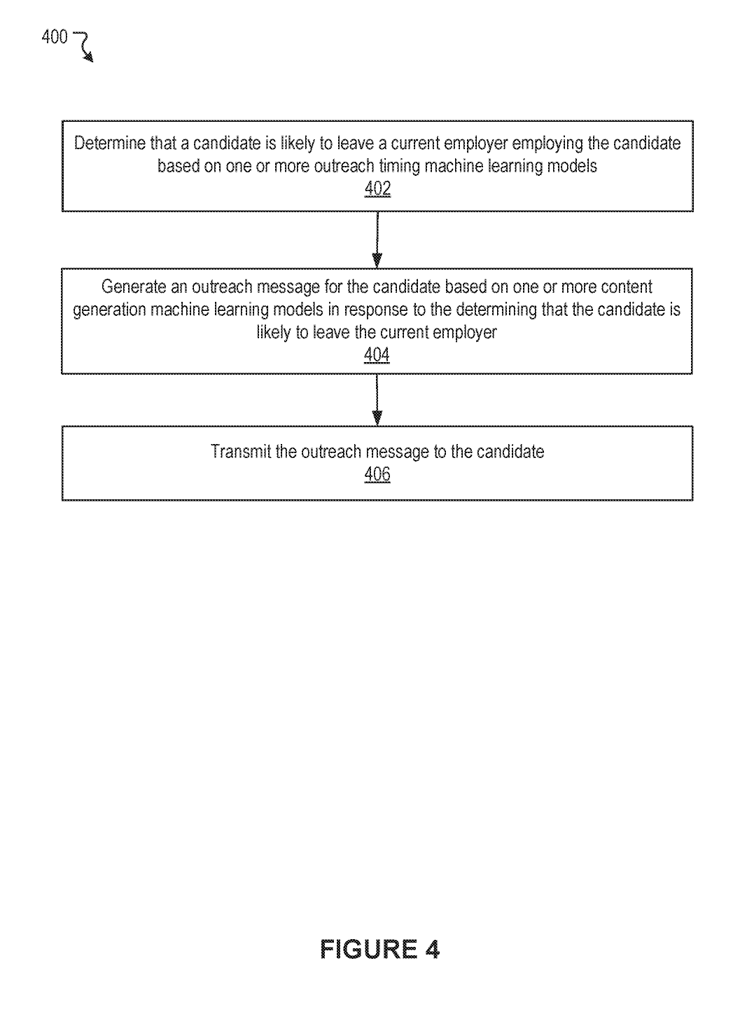

FIG. 4 illustrates an example method 400 associated with automated candidate outreach, according to an embodiment of the present disclosure. It should be appreciated that there can be additional, fewer, or alternative steps performed in similar or alternative orders, or in parallel, within the scope of the various embodiments discussed herein unless otherwise stated.

At block 402, the example method 400 can determine that a candidate is likely to leave a current employer employing the candidate based on one or more outreach timing machine learning models. At block 404, the example method 400 can generate an outreach message for the candidate based on one or more content generation machine learning models in response to the determining that the candidate is likely to leave the current employer. At block 406, the example method 400 can transmit the outreach message to the candidate.

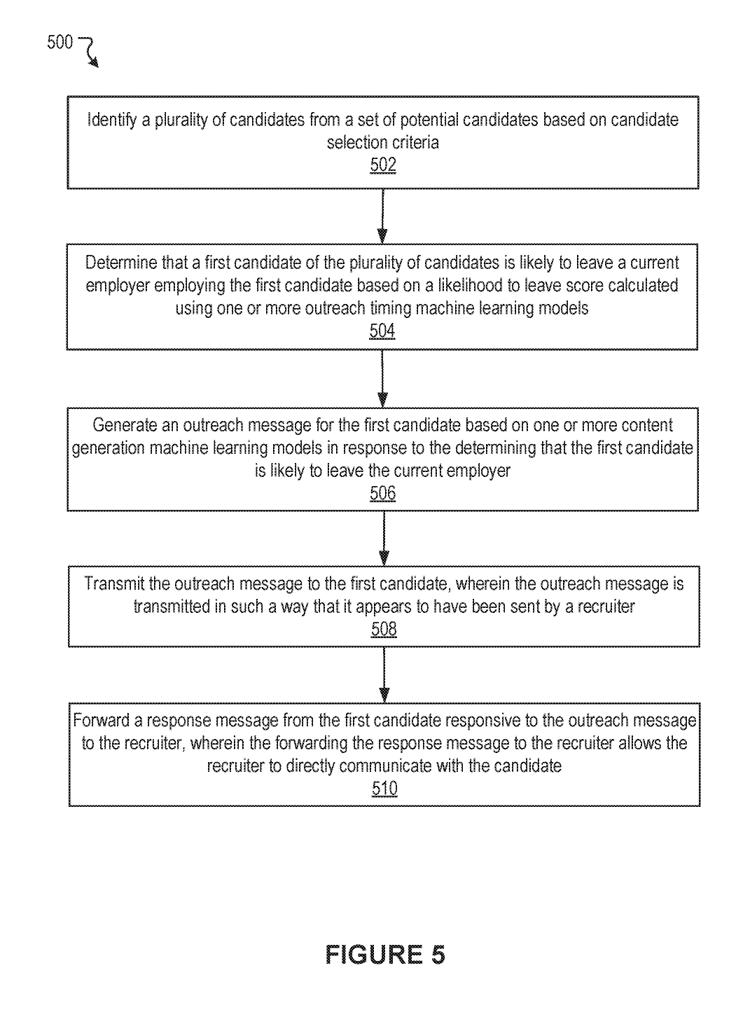

FIG. 5 illustrates an example method 500 associated with automated communications with a candidate, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can identify a plurality of candidates from a set of potential candidates based on candidate selection criteria. At block 504, the example method 500 can determine that a first candidate of the plurality of candidates is likely to leave a current employer employing the first candidate based on a likelihood to leave score calculated using one or more outreach timing machine learning models. At block 506, the example method 500 can generate an outreach message for the first candidate based on one or more content generation machine learning models in response to the determining that the first candidate is likely to leave the current employer. At block 508, the example method 500 can transmit the outreach message to the first candidate, wherein the outreach message is transmitted in such a way that it appears to have been sent by a recruiter. At block 510, the example method 500 can forward a response message from the first candidate responsive to the outreach message to the recruiter, wherein the forwarding the response message to the recruiter allows the recruiter to directly communicate with the candidate.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an automated candidate outreach module 646. The automated candidate outreach module 646 can, for example, be implemented as the automated candidate outreach module 102, as discussed in more detail herein. As discussed previously, it should be appreciated that there can be many variations or other possibilities. For example, in some embodiments, one or more functionalities of the automated candidate outreach module 646 can be implemented in the user device 610.

### Hardware Implementation

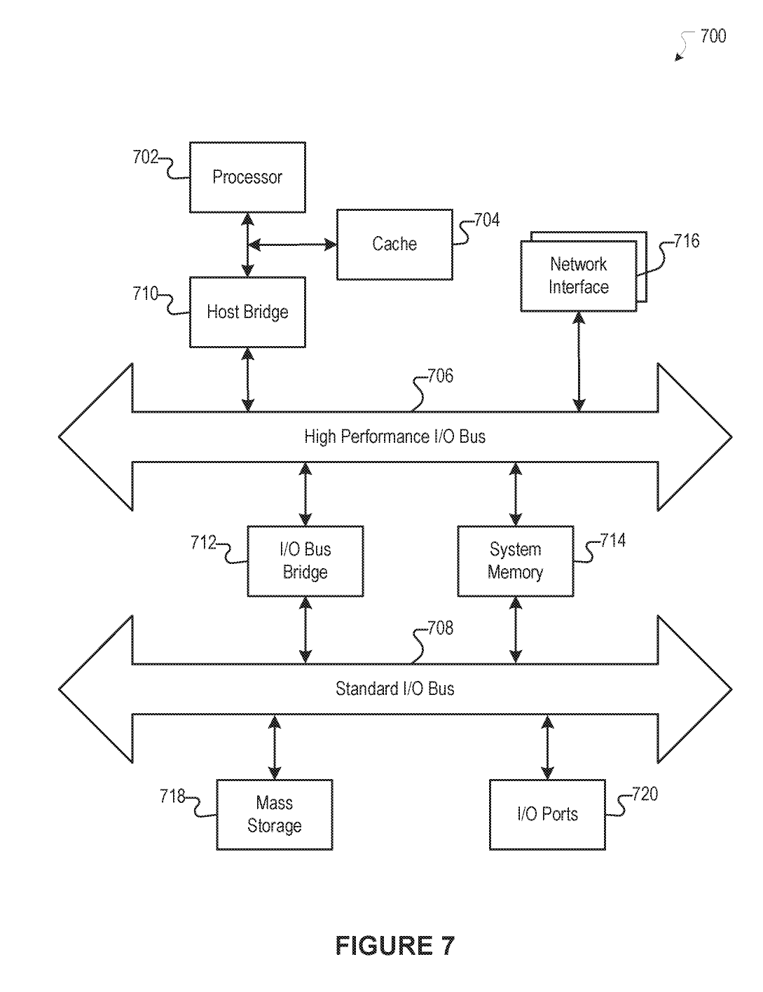

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, that a candidate is likely to leave a current employer employing the candidate based on one or more outreach timing machine learning models;
generating, by the computing system, an outreach message for the candidate based on one or more content generation machine learning models in response to the determining that the candidate is likely to leave the current employer; and
transmitting, by the computing system, the outreach message to the candidate.

2. The computer-implemented method of claim 1, wherein the determining that the candidate is likely to leave the current employer comprises:
calculating, based on the one or more outreach timing machine learning models, a likelihood to leave score indicative of a likelihood of the candidate to leave the current employer; and
determining that the likelihood to leave score satisfies a score threshold.

3. The computer-implemented method of claim 2, wherein the likelihood to leave score is calculated based on at least one of: an amount of time the candidate has been employed by the current employer; current employer stock price information;
current employer acquisition information; and current employer benefit information.

4. The computer-implemented method of claim 1, wherein the outreach message is transmitted to the candidate in such a way that it appears to the candidate that the outreach message was transmitted by a recruiter.

5. The computer-implemented method of claim 4, wherein the outreach message is transmitted to the candidate using an email address associated with the recruiter.

6. The computer-implemented method of claim 5, further comprising:
receiving a response message from the candidate responsive to the outreach message; and
forwarding the response message to the recruiter.

7. The computer-implemented method of claim 6, wherein the response message is forwarded to the recruiter based on a determination that the response message comprises a positive response to the outreach message.

8. The computer-implemented method of claim 1, wherein the outreach message comprises an invitation to apply for a position with a hiring employer.

9. The computer-implemented method of claim 8, wherein the generating the outreach message comprises:
identifying one or more connections of the candidate on a social networking system that are employed by the hiring employer; and
including at least one connection of the one or more connections in the outreach message.

10. The computer-implemented method of claim 9, further comprising:
receiving a response message from the candidate responsive to the outreach message; and
notifying the at least one connection of the response message.

11. A system comprising:
at least one processor; and
a memory storing instructions that, when executed by the at least one processor, cause the system to perform a method comprising:
determining that a candidate is likely to leave a current employer employing the candidate based on one or more outreach timing machine learning models;
generating an outreach message for the candidate based on one or more content generation machine learning models in response to the determining that the candidate is likely to leave the current employer; and
transmitting the outreach message to the candidate.

12. The system of claim 11, wherein the determining that the candidate is likely to leave the current employer comprises:
calculating, based on the one or more outreach timing machine learning models, a likelihood to leave score indicative of a likelihood of the candidate to leave the current employer; and
determining that the likelihood to leave score satisfies a score threshold.

13. The system of claim 12, wherein the likelihood to leave score is calculated based on at least one of: an amount of time the candidate has been employed by the current employer; current employer stock price information; current employer acquisition information; and current employer benefit information.

14. The system of claim 11, wherein the outreach message is transmitted to the candidate in such a way that it appears to the candidate that the outreach message was transmitted by a recruiter.

15. The system of claim 14, wherein the outreach message is transmitted to the candidate using an email address associated with the recruiter.

16. A non-transitory computer-readable storage medium including instructions that, when executed by at least one processor of a computing system, cause the computing system to perform a method comprising:
determining that a candidate is likely to leave a current employer employing the candidate based on one or more outreach timing machine learning models;
generating an outreach message for the candidate based on one or more content generation machine learning models in response to the determining that the candidate is likely to leave the current employer; and
transmitting the outreach message to the candidate.

17. The non-transitory computer-readable storage medium of claim 16, wherein the determining that the candidate is likely to leave the current employer comprises:
calculating, based on the one or more outreach timing machine learning models, a likelihood to leave score indicative of a likelihood of the candidate to leave the current employer; and
determining that the likelihood to leave score satisfies a score threshold.

18. The non-transitory computer-readable storage medium of claim 17, wherein the likelihood to leave score is calculated based on at least one of: an amount of time the candidate has been employed by the current employer; current employer stock price information; current employer acquisition information; and current employer benefit information.

19. The non-transitory computer-readable storage medium of claim 16, wherein the outreach message is transmitted to the candidate in such a way that it appears to the candidate that the outreach message was transmitted by a recruiter.

20. The non-transitory computer-readable storage medium of claim 19, wherein the outreach message is transmitted to the candidate using an email address associated with the recruiter.
